(19) United States
(12) Patent Application Publication
(10) Pub. No.: US 2010/0205019 A1
(43) Pub. Date: Aug. 12, 2010

(54) ARCHITECTURE AND METHOD FOR COMBINING COST DATA IN AUTOMATED MISSION PLANNERS

(75) Inventors: Adam L. Jung, Owego, NY (US); Thomas V. Monaco, Vestal, NY (US); Keith S. Sheppard, South West Harbor, ME (US); Robert J. Szczerba, Maine, NY (US); Raymond A. Tordoft, Vestal, NY (US)

Correspondence Address: TAROLLI, SUNDHEIM, COVELL & TUMMINO LLP, 1300 East Ninth Street- Suite 1700, Cleveland, OH, 44114, US

(73) Assignee: Lockheed Martin Corporation

(21) Appl. No.: 12/366,912

(22) Filed: Feb. 6, 2009

(51) Int. Cl. G06Q 10/00

(52) U.S. Cl. 705/7

(57) ABSTRACT

A system and method for combining cost maps including a multiplicity of cost service components for converting raw planning factors into standardized cost factors. A cost combiner component combines cost factors according to a cost configuration to generate a combined cost map

### FIELD OF THE INVENTION

The present invention relates to a system that combines cost data in automated mission planners. Such a system is used, for example, as a decision aid in automatically generating routes for vehicles.

2. Background of the Invention

Automated planning is an area of dynamic development. Such planning can be used, for example, by users as a decision aid to automatically generate routes for vehicles. Typically, they use a cost map to capture information relevant to planning. For example, for an air vehicle, the elevation of the ground is relevant for avoiding crashing into it. A cost map for such a planner might, therefore, consist of or utilize a geo-referenced grid of terrain elevations to plan routes.

Furthermore, this cost map may be a combination of multiple cost factors. For example, a ground vehicle may find it more difficult to traverse forest than road. It may also find traversal of flat terrain easier than mountainous terrain. In this case, a cost map might be comprised of a geo-referenced grid of a combination of terrain elevation and terrain type. In a dynamic environment, there may be dynamic, as well as static, cost factors. For example, during travel, a vehicle may discover, either through its own sensors or though communicated information, the existence of a threat. An on-board route planner could then alter the route to avoid the threat. One way to do this could be to add cost to the cost map based on the position and characteristics of the threat.

Furthermore, during travel a vehicle may have objectives or constraints changed. For example, a military vehicle may be instructed to avoid detection. This may alter the weighting of cost factors in the combination. In this case, a geo-referenced grid of estimated detection cost might change from zero to non-zero.

Traditionally, cost maps have been either a static combination of static cost factors or a static combination of static and dynamic cost factors. In either case, the combination has been tailored to a specific use case. This makes translation to a new use case challenging and adaptation of the cost map to shifting priorities during travel impossible.

2. The Prior Art

Several patents relating generally to the foregoing have been uncovered. Some of these patents focus on cross-usage, rather than derivation. This includes U.S. Pat. No. 6,175,804 to Szczerba; U.S. Pat. No. 6,259,988 to Galkowski et al.; U.S. Pat. No. 7,243,008 to Stockdale et al.; and U.S. Publication No. 2005/0216182 to Hussain et al.

In addition to the foregoing, some of the prior art patents focus on computation or representation of the cost factors themselves, not their combination. This includes U.S. Pat. No. 6,026,384 to Poppen; U.S. Pat. No. 6,484,092 to Seibel; U.S. Pat. No. 6,963,800 to Milbert; and, U.S. Publication Nos. 2005/0261828 to Crowder, Jr. et al.; and 2006/0116814 to Milbert.

In addition to the foregoing, other prior art patents tend to specify the combination method a priori rather than in a configurable and dynamic fashion, including U.S. Pat. No. 5,893,081 to Poppen and U.S. Pat. No. 6,182,007 to Szczerba

### SUMMARY OF THE INVENTION

In accordance with one aspect of the present invention, a system is provided herein for purposes of combining cost factors into cost maps. This system includes a multiplicity of cost service components that convert raw planning factors into standardized cost factors. A cost combiner component is provided for combining cost factors according to a cost configuration to generate a combined cost map.

In accordance with another aspect of the present invention, a method is provided that combines cost factors into cost maps. This method includes the steps of receiving a multiplicity of cost service components for converting raw planning factors into standardized cost factors.

In addition to the foregoing, there is provided a computer readable medium that has a computer program product that combines cost factors into cost maps. This computer program product includes a plurality of instructions including instructions for converting raw planning factors into standardized cost factors. The cost factors are combined according to a cost configuration to generate a combined cost map.

### BRIEF DESCRIPTION OF THE DRAWINGS

The foregoing and other features of the present invention will become apparent to one skilled in the art to which the present invention relates upon consideration of the following description of the invention with reference to the accompanying drawings, wherein:

FIG. 1 is a block diagram illustration of the architecture employed in processing the invention;

FIG. 2 is a block diagram illustration of portions of that shown in FIG. 1, but in greater detail; and

FIG. 3 is a block diagram illustration of a computer that may be employed in conjunction with practicing the invention herein.

### DESCRIPTION OF EXAMPLE EMBODIMENT

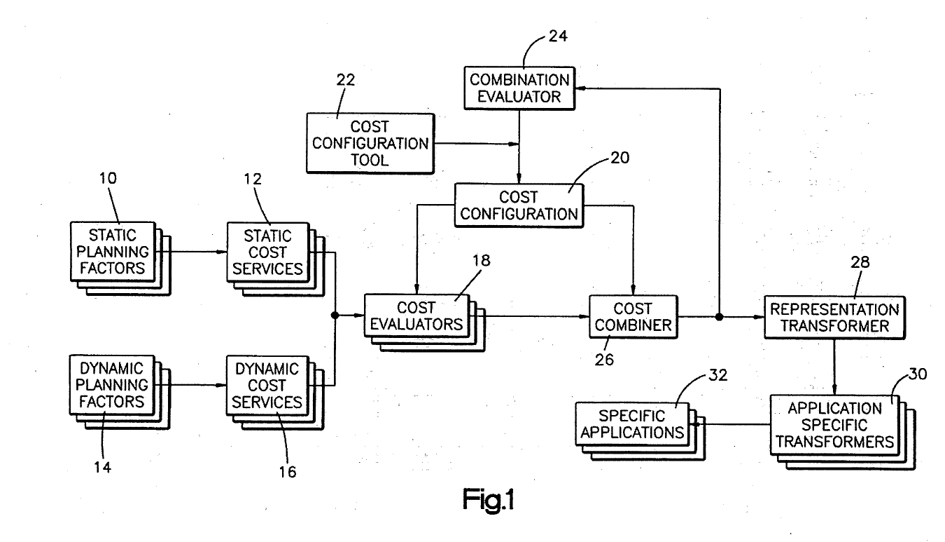

The invention herein is presented as an architecture and method for combining cost data in automated mission planners. A number of architectural components are employed to generate and combine cost factors into a cost map. These components and the methods flowing through them are presented herein (see FIG. 1). There is a cost configuration tool that can be employed by a user for automated systems to generate cost factor and cost weighting and prioritization and configuration. There are cost factor configuration data that define how cost factors are evaluated. The combined cost is transformed into a more convenient form referred to herein as transformed cost. This may be a grid based cost map, rather than a graph based cost map or vice versa. Application-specific services perform application-specific formatting transformations for use by an application. The combined cost is evaluated by the combination evaluator service for suitability. This service may or may not have human involvement. This evaluation is used for feedback to the cost configuration tool. This tool uses knowledge gained by the evaluation to improve the configuration controlling the cost evaluators and cost combiner.

As shown in FIG. 1, static planning factors 10 are presented as data which are inputted to static cost services 12. Similarly, data, in the sense of dynamic planning factors 14, are inputted to dynamic cost services 16. The data presented to the cost services 12 and 16 are supplied to cost evaluators 18, along with data from the cost configuration 20. This cost configuration 20 receives data from a cost configuration tool 22 and a combination evaluator 24. The cost configuration 20 and cost evaluators 18 are supplied to a cost combiner 26 which provides feedback to the combination evaluator 24. The output from the cost combiner is supplied to a representation transformer 28 which, in turn, supplies the application-specific transformers 30 and, thence, to the specific applications 32.

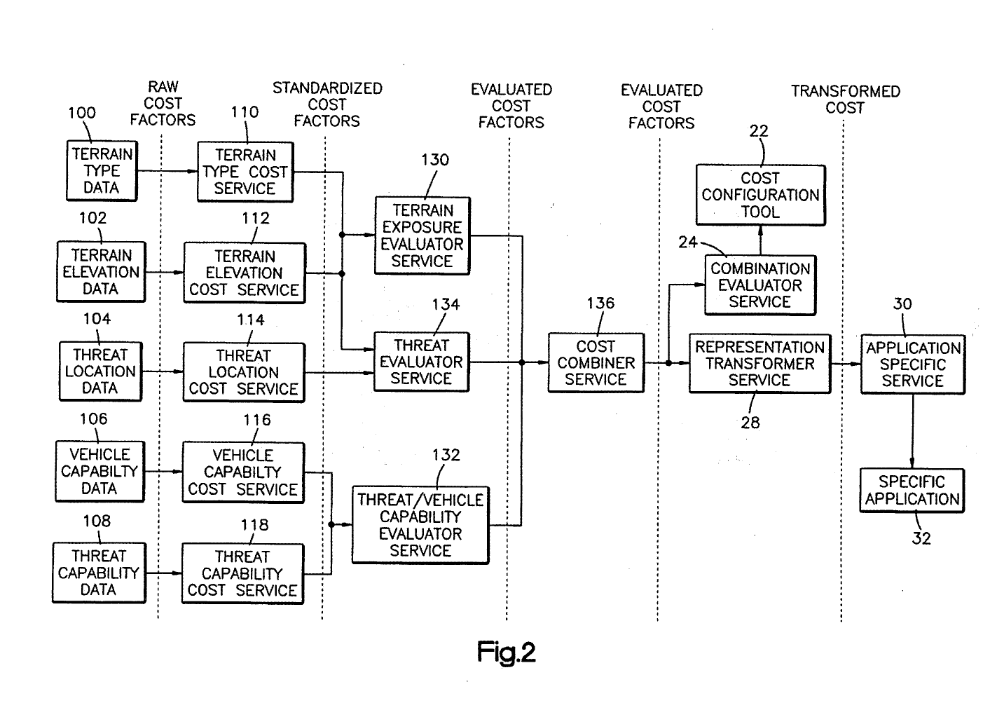

Reference is now made to FIG. 2, which provides additional information regarding the invention. As shown in FIG. 2, there are three static cost factors and these include terrain-type data 100, terrain elevation data 102 and threat location data 104. Additionally, there are two dynamic cost factors including vehicle capability data 106 and threat capability data 108. These are all considered raw cost factors 100-108. They are each handled by a cost service, including a terrain-type cost service 110, a terrain elevation cost service 112, a threat location cost service 114, a vehicle capability cost service 116 and a threat capability cost service 118. These cost services 110-118 produce standardized cost factors.

These standardized cost factors are combined into evaluated cost factors by cost evaluators. Thus, a terrain exposure evaluator service 130 combines the terrain elevation and terrain types to calculate terrain exposure. A threat-vehicle capability evaluator service 132 combines vehicle capability and threat capability into threat against vehicle capability. A threat evaluator service 134 combines the threat against vehicle capability with threat location and terrain elevation to provide threat inter-visibility.

A cost combiner service 136 combines the foregoing evaluated cost factors according to a configured formula into a combined cost. This formula may be, but is not limited to, a linear combination of evaluated cost factors.

This combined cost from the cost combiner service 136 is then transformed into a more convenient form: called transformed cost, for example, a grid-based cost map rather than a graph-based cost map, or vice versa. This cost combiner service 136 of FIG. 2 may be considered as the cost combiner 26 in FIG. 1. The combined cost is evaluated by the combination evaluator service 24 for suitability. This service may or may not employ human involvement. This evaluation is used for feedback to the cost configuration tool 22 which uses the, knowledge gained by the evaluation to improve the configuration controlling the cost evaluators and the cost combiner.

By providing a way of combining cost factors in different ways as well as extending itself to include additional cost factors, this architecture and method represents a significant advance over the state of the art.

The ability to combine cost factors in different ways extends the same automatic planner using the cost map to be applied to different situations, vehicles, and missions. Furthermore, these cost factors can be changed during the mission to react to changing situations and/or mission priorities. This capability supports the same automatic planner to replan in-mission, providing a higher fidelity planning capability in response to a rapidly changing situation.

In addition, the ability to extend the cost map to include future cost factors supports rapid adaptation and configuration to other or additional factors previously unsupported. Furthermore, the ability to provide feedback to the configuration based on the suitability of the resultant cost map to the problem at hand provides a capability to rapidly develop improvements in configuration.

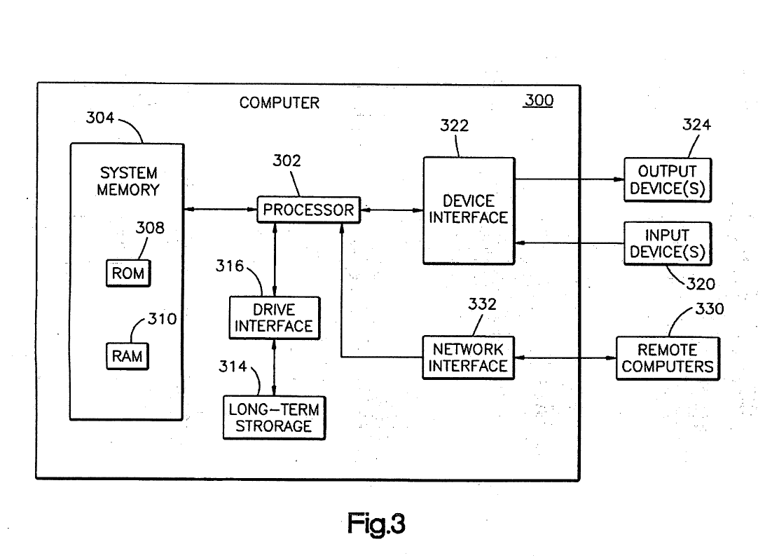

FIG. 3 illustrates a computer system 300 that can be employed to implement systems and methods described herein, such as based on computer executable instructions running on the computer system. The computer system 300 can be implemented on one or more general purpose networked computer systems, embedded computer, systems, routers, switches, server, devices, client devices, various intermediate devices/nodes and/or stand alone computer systems. Additionally, the computer system 300 can be implemented as part of the computer-aided engineering (CAE) tool running computer executable instructions to perform a method as described herein.

The computer system 300 includes a processor 302 and a system memory 304. Dual microprocessors and other multi-processor architectures can also be utilized as the processor 302. The processor 302 and system memory 304 can be coupled by any of several types of bus structures, including a memory bus or memory controller, a peripheral bus, and a local bus using any of a variety of bus architectures. The system memory 304 includes read only memory (ROM) 308 and random access memory (RAM) 310. A basic input/output system (BIOS) can reside in the ROM 308, generally containing the basic routines that help to transfer information between elements within the computer system 300, such as a reset or power-up.

The computer system 300 can include one or more types of long-term data storage 314, including a hard disk drive, a magnetic disk drive, (e.g., to read from or write to a removable disk), and an optical disk drive, (e.g., for reading a CD-ROM or DVD disk or to read from or write to other optical media). The long-term data storage can be connected to the processor 302 by a drive interface 316. The long-term storage components 314 provide nonvolatile storage of data, data structures, and computer-executable instructions for the computer system 300. A number of program modules may also be stored in one or more of the drives as well as in the RAM 310, including an operating system, one or more application programs, other program modules, and program data.

A user may enter commands and information into the computer system 300 through one or more input devices 320, such as a keyboard or a pointing device (e.g., a mouse). These and other input devices are often connected to the processor 302 through a device interface 322. For example, the input devices can be connected to the system bus 306 by one or more a parallel port, a serial port or a universal serial bus (USB). One or more output device(s) 324, such as a visual display device or printer, can also be connected to the processor 302 via the device interface 322.

The computer system 300 may operate in a networked environment using logical connections (e.g., a local area network (LAN) or wide area network (WAN) to one or more remote computers 330. The remote computer 330 may be a workstation, a computer system, a router, a peer device or other common network node, and typically includes many or all of the elements described relative to the computer system 300. The computer system 300 can communicate with the remote computers 330 via a network interface 332, such as a wired or wireless network interface card or modem. In a networked environment, application programs and program data depicted relative to the computer system 300, or portions thereof, may be stored in memory associated with the remote computers 330.

It will be understood that the above description of the present invention is susceptible to various modifications, changes and adaptations, and the same are intended to be comprehended within the meaning and range of equivalents of the appended claims. The presently disclosed embodiments are considered in all respects to be illustrative, and not restrictive. The scope of the invention is indicated by the appended claims, rather than the foregoing description.

Having described the invention, the following is claimed:

1. A system for combining cost factors into cost maps, said system comprising:
a multiplicity of cost service components for converting raw planning factors into standardized cost factors; and
a cost combiner component for combining cost factors according a cost configuration to generate a combined cost map.

2. A system as set forth in claim 1 wherein said cost service components includes static cost service components for converting raw static planning factors into said standardized cost factors.

3. A system as set forth in claim 2 wherein said cost service components include dynamic cost service components for converting raw dynamic planning factors into standardized cost factors.

4. A system as set forth in claim 3 including a multiplicity of cost evaluator components for evaluating one or more standardized cost factors into the cost.

5. A system as set forth in claim 4 wherein said cost configuration includes a cost weighting and prioritization configuration.

6. A system as set forth in claim 5 including a representation transformer component for transforming the representation of the cost map into different representations; and
a multiplicity of application specific transformer components for selecting representations appropriate to a specific application and performing any additional transformations that may be needed.

7. The system as set forth in claim 6 wherein said system further includes:
a cost configuration tool component for generating cost factor and cost weighting and prioritization configuration;
a multiplicity of cost factor configuration data component for defining how cost factors are evaluated.

8. The system as set forth in claim 6 further including:
a combination evaluator component for evaluating the suitability of a resulting cost map to a particular problem and adjust the cost configuration to suit, learning the problem.

9. A system as set forth in claim 8 further including:
a cost configuration tool component for generating cost factor and cost weighting and prioritization configuration; and
a multiplicity of cost factor configuration data components for defining how cost factors are evaluated.

10. A system as set forth in claim 6 including static data entry means that enter said raw static planning factors into said static cost service components.

11. A system as set forth in claim 06 including dynamic data entry means that enters said raw dynamic planning factors into said dynamic cost service components.

12. A system as set forth in claim 6 including:
static data entry means that enter said raw static planning factors into said static cost service components; and
dynamic data entry means that enters said raw dynamic planning factors into said dynamic cost service components.

13. A system as set forth in claim 8 including static data entry means that enter said raw static planning factors into said static cost service components.

14. A system as set forth in claim 13 including dynamic data entry means dynamic data entry means that enters said raw dynamic planning factors into said dynamic cost service components.

15. A system a set forth in claim 13 including static data entry means that enter said raw static planning factors into said static cost surface components and dynamic data entry means that enters said raw dynamic planning factors into said dynamic cost service components.

16. A method for combining cross factors into cost maps wherein said method includes the steps of:
receiving a multiplicity of cost service components for converting raw planning factors into standardized cost factors;
combining cost factors according to a cost configuration to generate a combined cost map.

17. A method as set forth in claim 16 including the further steps of transforming a representation of the cost map into different representations and selecting representations appropriate to a specific application and performing any additional transformations that may be needed.

18. A computer readable medium having a computer program product for combining cost factors into cost maps, said computer program product comprising:
a first instruction for converting raw planning factors into standardized cost factors;
a second instruction for combining cost factors according to a cost configuration to generate a combined cost map.

19. The computer readable medium as set forth in claim 18 including a third instruction for transforming a representation of the cost map into different representations and a fourth instruction for selecting representations appropriate to a specific application and performing any additional transformations that may be needed.

20. A computer readable medium as set forth in claim 19 including the further step of defining how cost factors are evaluated.
